(19) United States
(12) Patent Application Publication
(10) Pub. No.: US 2016/0117691 A1
(43) Pub. Date: Apr. 28, 2016

(54) Aggregating Foodstuff Data

(71) Applicant: Cookbrite Inc., Mercer Island, WA (US)

(72) Inventors: Court V. Lorenzini, Mercer Island, WA (US); Samuel Anthony Lucente, II, San Francisco, CA (US)

(73) Assignee: COOKBRITE INC., Mercer Island, WA (US)

(21) Appl. No.: 14/526,451

(22) Filed: Oct. 28, 2014

(51) Int. Cl. G06Q 30/02

(52) U.S. Cl. CPC G06Q 30/0201; G06Q 30/0217

(57) ABSTRACT

Systems and methods for providing aggregated foodstuff usage data to one or more foodstuff vendors are provided. A computer-executable tool (typically in the form of an app or application) is provided to a plurality of users/consumers. The computer-executable tool includes features that encourage its use and the tool reports foodstuff usage data to a foodstuff data aggregator. The foodstuff data aggregator aggregates the foodstuff usage data from a plurality of users, organized according to a variety of aspects for easy identification and retrieve in response to a request from a foodstuff vendor. The foodstuff data aggregator is also configured to assist the plurality of users in regard to various rewards, loyalty, and offer programs from the various vendors.

### BACKGROUND

In the current environment, while vendors of many types of goods are able to identify (to some degree or another) the consumers of their goods and, in many cases, provide customer loyalty and reward programs, at least one substantial segment of vendors is left out of this ability: foodstuff vendors. More particularly, in the current environment, a foodstuff vendor is unable to acquire information regarding household foodstuff usage.

There are multiple reasons that foodstuff vendors cannot gain access to consumer usage, but the primary reason is due to the current, ubiquitous method by which consumers purchase foodstuff items—through a grocery store. While a vendor will most likely be able to determine the amount of goods it provides to various grocery stores, such information is nearly the extent of the information that a vendor is able to access. Even when consumers utilize coupons, the coupons are generally redeemed through the grocery stores such that information regarding the consumer that redeems the coupon is not relayed to the vendor. In short, the grocery stores do not share information regarding their customers with vendors—i.e., what a specific household may purchase, when, how much, which brands, and the like.

### SUMMARY

The following Summary is provided to introduce a selection of concepts in a simplified form that are further described below in the Detailed Description. The Summary is not intended to identify key features or essential features of the claimed subject matter, nor is it intended to be used to limit the scope of the claimed subject matter.

According to aspects of the disclosed subject matter, systems and methods for providing aggregated foodstuff usage data to one or more foodstuff vendors is provided. A computer executable tool (typically in the form of an app or application) is provided to a plurality of users/consumers. The computer executable tool includes features that encourage its use and the tool reports foodstuff usage data to a foodstuff data aggregator. The foodstuff data aggregator aggregates the foodstuff usage data from a plurality of users, organized according to a variety of aspects for easy identification and retrieve in response to a request from a foodstuff vendor. The foodstuff data aggregator is also configured to assist the plurality of users in regard to various rewards, loyalty, and offer programs from the various vendors.

According to additional aspects of the disclosed subject matter, a method for gathering and providing user foodstuff data for foodstuff vendor requests is provided. The method includes providing a computer-executable tool (such as an app or application) to a plurality of users, and where the computer-executable tool is configured to transmit foodstuff data to a foodstuff data aggregator regarding the plurality of users. The method further includes obtaining the foodstuff data from the plurality of users and aggregating the obtained foodstuff data from the plurality of users. Thereafter, upon receiving a foodstuff data request from a foodstuff vendor, a set of results is identified from the aggregated foodstuff data that satisfies the request according to various criteria of the request. At least some of the identified set of results to the foodstuff vendor in response to the foodstuff data request.

### BRIEF DESCRIPTION OF THE DRAWINGS

The foregoing aspects and many of the attendant advantages of the disclosed subject matter will become more readily appreciated as they are better understood by reference to the following description when taken in conjunction with the following drawings, wherein:

FIGS. 1A and 1B are pictorial diagrams illustrating an exemplary foodstuff data aggregation service environment suitable for implementing aspects of the disclosed subject matter;

FIG. 2 is a pictorial diagram illustrating an exemplary process flow of the foodstuff data aggregator process between the user/consumer and the data aggregator;

FIGS. 3A-3C illustrate a flow diagram of an exemplary routine suitable for use by a data aggregator to interface with the user/consumer;

FIG. 4 is a flow diagram illustrating an exemplary routine suitable for use by the data aggregator to manage the reward system for the user/consumer;

FIG. 5 is a flow diagram illustrating an exemplary routine suitable for use by the data aggregator to interface with vendors;

FIG. 6 is a block diagram illustrating exemplary components of a computing system suitable for implementing a foodstuff data aggregator for aggregating foodstuff data from a plurality of users/consumers and/or consumer households, and further configured to interact with one or more foodstuff vendors as described above and according to the aspects of the disclosed subject matter; and

FIG. 7 is a block diagram illustrating exemplary components of a user computing system suitable for hosting a computer-executable tool for communicating with a foodstuff data aggregator, according to the aspects of the disclosed subject matter.

### DETAILED DESCRIPTION

For the purposes of clarity, the term “exemplary” in this document should be interpreted as serving as an illustration or example of something, and it should not be interpreted as an ideal and/or a leading illustration of that thing.

The term “foodstuff” or “foodstuff items” should be interpreted as comprising items sold in a grocery store including food items and ingredients used in the preparation of food items. Correspondingly, a “foodstuff vendor” is a vendor that provides foodstuff items to grocery stores (either directly or through intermediaries.)

The term “foodstuff-related items” refers to items that are commonly used in regard to foodstuff preparation. Measuring cups, knives, colanders, parchment paper, foil, cooking spray, dishes, and the like are non-limiting examples of foodstuff-related items. The term “foodstuff usage data” corresponds to information regarding the purchase, preparation, and consumption of foodstuff items as well as the purchase and use of foodstuff-related items.

The term “household” refers to a consumer household in which one or more persons are commonly participating in meals. Thus, when the foodstuff data aggregator obtains information regarding a “household,” the foodstuff usage data is viewed (and normalized) in terms of the number of persons in the particular household. Additionally, foodstuff usage data may include the number of people that are guests to a household—a temporary modification to the number of people that are members of the household.

According to aspects of the disclosed subject matter, a foodstuff data aggregator provides a computer-executable tool to a plurality of consumers. Typically, but not exclusively, the computer-executable is an app or application that may be used by a consumer (or user, as in user of the app/application) and a foodstuff data aggregator is an online entity or service that operates independently of foodstuff vendors. The computer-executable tool provided by the foodstuff data aggregator is able to determine various aspects of foodstuff purchase and consumption of the plurality of consumers and/or consumer households through usage of the tool. As will be more clearly presented below, all or portions of the foodstuff data aggregator may be suitably used to track non-foodstuff purchases and consumption.

Generally speaking, the computer-executable tool reports foodstuff usage data and/or information regarding consumer purchase and consumption of foodstuffs back to the foodstuff data aggregator. The foodstuff data aggregator is configured to receive the foodstuff usage data from the plurality of consumers (or consumer households) using the computer-executable tool and make the foodstuff data available to the foodstuff vendors. According to various embodiments of the disclosed subject matter, the foodstuff data made available to the foodstuff vendors may include (by way of illustration and not limitation) specific foodstuff items purchased, prepared, and/or consumed (including brand-name information regarding the foodstuff items); quantities of foodstuff items; when the foodstuff items were purchased, prepared and/or consumed; demographic information regarding the consumer and/or consumer household; and the like. Generally, specific information regarding the identities of the consumers and/or consumer households is not available to the vendors without consumer agreement, though in some instances specific information may be provided (e.g., when loyalty programs, special offers, coupons, etc. are used).

In addition to aggregating foodstuff data and providing that data to vendors, the foodstuff data aggregator may also assist both the consumer and the foodstuff vendors in maintaining and carrying out one or more rewards programs for consumers. The term “rewards program” is used generically for a variety of programs that may include, by way of illustration and not limitation, the redemption (on behalf of a consumer) of one or more coupons and or offers from vendors, the implementation of a loyalty program, providing special offers to the consumers/users, and the like.

As will be discussed in greater detail below and according to at least one non-limiting embodiment, a foodstuff data aggregator is an online entity and/or service that, in many embodiments, operates independently of foodstuff vendors. The foodstuff data aggregator amasses foodstuff usage data (including the aggregation information/data described above) from a plurality of consumers and/or consumer households (by way of consumer use of the computer-executable tool), and makes the aggregated foodstuff usage data available to the foodstuff vendors. Of course, it should be appreciated that while the foodstuff data aggregators may operate independently of any foodstuff vendor, such independent operation is not necessary or mandatory. In various alternative embodiments, a foodstuff data aggregator may be implemented and operated by a foodstuff vendor or multiple foodstuff vendors.

According to aspects of the disclosed subject matter, the “computer-executable tool” provided by the foodstuff data aggregator that is provided to report foodstuff usage data may be implemented as a computer-implemented app or application that encourages users (consumers) of the app to provide information regarding the planning, purchase, and consumption of foodstuff items. As will be appreciated, an “app” is a software application that typically (though not exclusively) runs on a user's mobile computing device. Apps are generally smaller in size and resource usage than a typical software application and are often focused on a single or small set of tasks, such as meal planning, foodstuff acquisition and preparation. Further still, the “computer-executable tool” may be implemented as a “web app.” A web app corresponds to executable (or interpreted) code that a computer user can execute by way of a web browser executing on a computing device. Of course, apps, applications and web apps may be implemented on mobile devices as well as other computing devices such as desktop computers, laptop computers, and the like. According to aspects of the disclosed subject matter, the tool/app provided by the foodstuff data aggregator includes useful and valuable features and services, including meal planning, foodstuff acquisition and preparation, which encourage user interaction with the tool/app. This encouragement is accomplished through convenient and useful services implemented by the app. These useful and convenient services may include, but are not limited to, providing consumer-specific coupons, generating shopping lists, tracking foodstuff restrictions (e.g., allergies and/or dietary preferences) and assisting in planning and organizing dishes and meals under such restrictions, tracking non-foodstuff item preferences and purchase patterns, organizing and maintaining recipes, pricing information, meal planning, consumption patterns, coordinating timing of purchasing perishable foodstuff items, and the like. Any one or multiple combinations of these useful services may be provided to the user/consumer.

While the following discussion is generally made in regard to aggregating foodstuff data, it should be appreciated that the disclosed subject matter may be readily and advantageously applied to capturing non-foodstuff data, including foodstuff-related items, which information is similarly unavailable to vendors, i.e., non-foodstuff items that may be purchased through a typical grocer or similar vendor in which the information surrounding the purchase/sale of such items with regard to particular purchasers/households is not available from the vendor. For example, a typical grocer may sell non-foodstuff items, such (by way of illustration and not limitation) as toiletries, automotive items, paper goods, cooking utensils, and the like, and the information regarding these sales to particular individuals and/or households is closely maintained and kept by the grocer. However, through the use of the computer-executable tool, non-foodstuff items may be placed on a purchase list such that the user is prompted to purchase (and report the use of) these items just as he/she may be prompted to purchase foodstuff items through the computer-executable tool, and that information may be aggregated as disclosed herein.

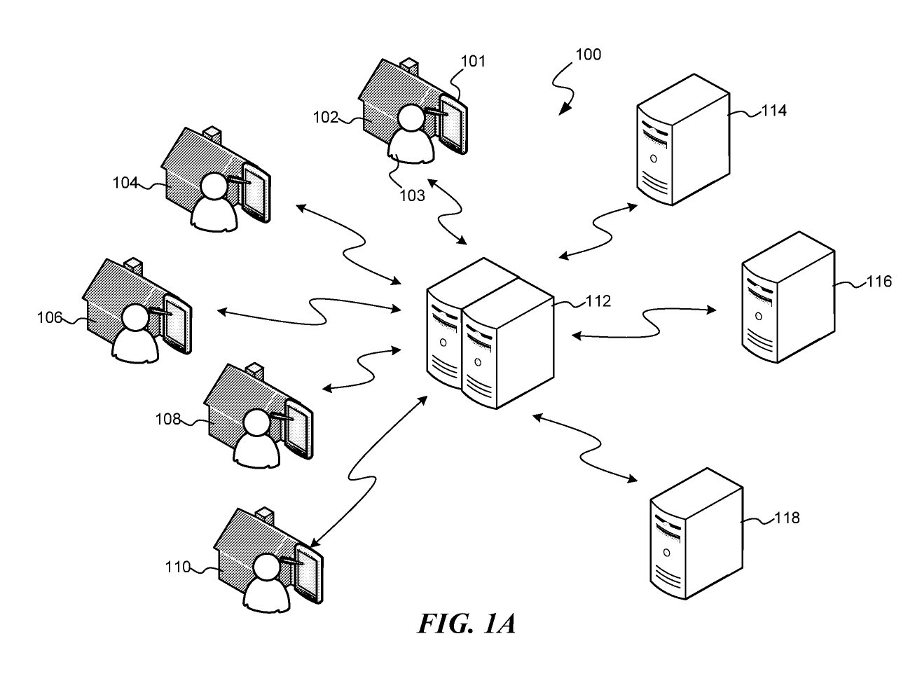

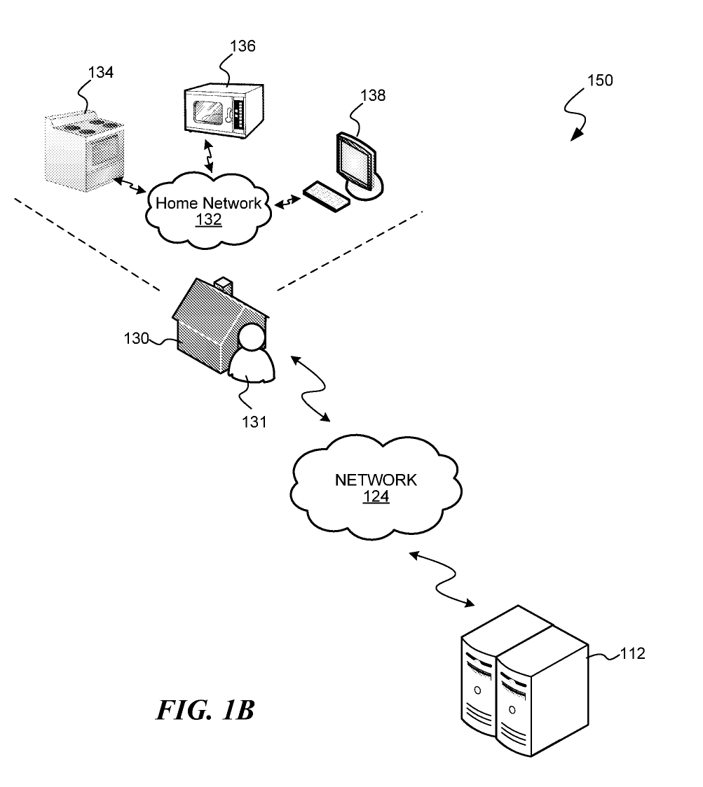

Turning to the figures, FIG. 1A is a pictorial diagram illustrating an exemplary foodstuff data aggregation environment 100 suitable for implementing aspects of the disclosed subject matter. In particular, the exemplary foodstuff data aggregation environment 100 is suitable for gathering and aggregating foodstuff data and providing useful services to a plurality of consumer households, such as consumer households 102-110, in which a user/consumer, such as user 103 of consumer household 102, interacts with the app by way of one or more computing devices, such as computing device 101. Through the use of the computer-executable tool, the computing device 101 may be configured to provide a variety of useful features and services to a user, such as user 103, and through the use of the tool generates foodstuff usage data that is submitted to a foodstuff data aggregator 112. In turn, the foodstuff data aggregator 112 aggregates the foodstuff usage data from a plurality of users (corresponding to consumer households) and provides the aggregated foodstuff data to one or more of the foodstuff vendors 114-118 (and/or related partners) over a wide area network, such as network 124 shown in FIG. 1B. As will be readily appreciated, user computer devices may include, by way of illustration and not limitation: consumer consoles, tablet computing devices, such as tablet computing device 101; smart phone devices; so-called “phablet” computing devices (i.e., computing devices that straddle the functionality of typical tablet computing devices and smart phone devices); network connected TVs, laptop computers; desktop computing devices; wearable computing devices and/or sensors, embedded devices (i.e., household appliances and devices having an embedded computing ability); personal digital assistants, and the like.

Generally speaking, a user/consumer, such as user 103, provides foodstuff usage data regarding the user's household (such as consumer household 102) to the foodstuff data aggregator 112 by way of the computer-executable tool provided to the user. This foodstuff data may include, by way of illustration and not limitation, foodstuff purchase information (what was purchased, quantities purchases, where foodstuff items were purchased, when the foodstuff items were purchased), preparation and consumption of meals (including foodstuff ingredients), and the like. In addition to providing foodstuff usage data to the foodstuff data aggregator 112, the computer-executable tool obtains information from the foodstuff data aggregator 112. This obtained information/data may include, by way of illustration and not limitation, recipes, meal or “dish” preparation instructions (including recipe cards for preparing various dishes), shopping lists, and the like. For purposes of clarity, a “dish” refers to a particular element of an entire meal, such as an entree, an appetizer, a dessert, a side dish, and the like. In contrast, a meal is comprised of one or more dishes, typically (though not exclusively) including at least an entrée. Additionally, as an incentive to encourage user 103 to provide such foodstuff data and to incentivize purchase of various products, the foodstuff data aggregator 112 may provide directed awards or offers to users/consumers of the executable tool based on a user's specific foodstuff consumption, preparation, acquisition, and the like. The directed awards may include loyalty and reward programs including coupons targeted to specific household purchase and consumption rather than delivered by mass media methods.

As indicated above, the foodstuff data aggregation environment 100 also includes other various network services, such as foodstuff vendors 114-118. By way of the foodstuff data aggregator 112, the foodstuff vendors are able to access aggregated foodstuff data regarding consumer households, such as consumer households 102-110. As indicated above, examples of aggregated foodstuff data that may be provided to foodstuff vendors 114-118 include specific product/foodstuff purchase details, consumption information, consumption dates, brands purchased, and the like, all of which may be aggregated and organized in conjunction with specific demographic information. Moreover, in addition to providing the data to foodstuff vendors 114-118, aggregated foodstuff data may also be provided to partners (not shown) of foodstuff vendors. For example, a manufacturer of a rice steamer may not necessarily be identified as a foodstuff vendor 114-118, but could benefit from information regarding foodstuff usage in consumer households, particularly in regard to rice consumption and preparation. Moreover, in this example the manufacturer may form a strategic alliance with a rice/foodstuff vendor such that a reward or offer may be provided to consumers/households. Thus, according to aspects of the disclosed subject matter, aggregated foodstuff data may be made available to both vendors and to related and/or interested partners.

As will be appreciated, of course, the provision of foodstuff usage data from the computer-executable tool to the foodstuff data aggregator 112 should be made with the consent of the user/consumer as disclosure of such information may be viewed as disclosure of personal, private, and/or sensitive information. According to various embodiments of the disclosed subject matter, the individual user of the computer-executable tool is typically given the opportunity to opt in or opt out of providing his/her foodstuff usage data to the foodstuff data aggregator 112, though full use of the functionality and features of the computer-executable tool may be conditioned upon the user/consumer consenting to disclosure of his/her foodstuff usage data. Similarly, other security or privacy measures may be utilized in maintaining the security of personal, private and/or sensitive data such as anonymization of the usage data submitted by the user/consumer (such as user 103) to the foodstuff data aggregator 112 where certain demographic information of the user/consumer is disclosed without revealing particular information that specifically identifies the user/consumer. Alternatively, the foodstuff data aggregator 112 may be viewed as a trusted site such that specific information regarding the user/consumer can be provided, and that the foodstuff data aggregator 112 will maintain the privacy of that personal information regarding individual users and/or households. In this arrangement, the foodstuff data aggregator 112 would provide anonymized data to foodstuff vendors such that some demographic information regarding consumers/consumer households may be available but that individual consumers and/or households are not specifically identified. Anonymizing data in this manner is known in the art.

While FIG. 1A provides a broad view of a foodstuff data aggregation environment 100 with multiple consumer households 102-110 and multiple foodstuff vendors 114-118, FIG. 1B is a pictorial diagram illustrating an exemplary, more focused embodiment of a foodstuff data aggregator service environment 150. In particular, foodstuff data aggregator environment 150 is more suited for illustrating the interaction in regard to a user/consumer 131 providing foodstuff usage data concerning the associated consumer household 130 to the foodstuff data aggregator 112 over a network, such as network 124. As will be readily appreciated, a consumer household, such as consumer household 130, will typically include one or more appliances, such as appliances 134-136, as well as one or more computing devices, such as computing device 138. More and more, the appliances as well as computing devices will intercommunicate over a home network 132. Hence, a consumer's sources of foodstuff usage data provided to the foodstuff data aggregator 112 may include, but are not limited to, computing device 138, and appliances, such as range 134 and microwave 136, and the like. Further still, items in “smart packaging” (not shown) in which the packaging itself includes structure that communicates information regarding its contents may be a source of foodstuff data usage data by way of suitably configured appliances (e.g., a refrigerator) and household storage areas (e.g., cabinets, pantries, etc.) that are equipped to receive the communications from smart packaging. As will be appreciated, capturing data regarding foodstuff items (and non-foodstuff items) through smart packaging enables proactive tracking and/or monitoring of household inventory of such items.

Home appliances 134 and 136 may be configured such that specific appliance information, including brand, model, wattage, use duration, temperature, on/off mode, and the like, may be provided to the foodstuff data aggregator 112 by way of communicating over the home network 132 with one or more computer-executable tools executing on a computer, such as computing device 138. Additionally, information obtained from the foodstuff data aggregator 112 may be directed to various home appliances, such as appliances 134 and 136, including control instructions in regard to meal preparation. By way of example, foodstuff data aggregator 112 may receive a request from user/consumer 131 to bake a prepared foodstuff. In response, foodstuff data aggregator 112 may request and be provided with details concerning the current status of range 134 and provide instruction to one or more controlling devices (not shown) on home network 132 to turn “on” the range 134 and pre-heat it to the desired temperature. Regarding the home network 132, networks and networking is known in the art and, while the present document may make reference to the home network as a private network, in various embodiments the home network may refer to a public network, a peer to peer network, a mesh network, an ad-hoc network, and the like.

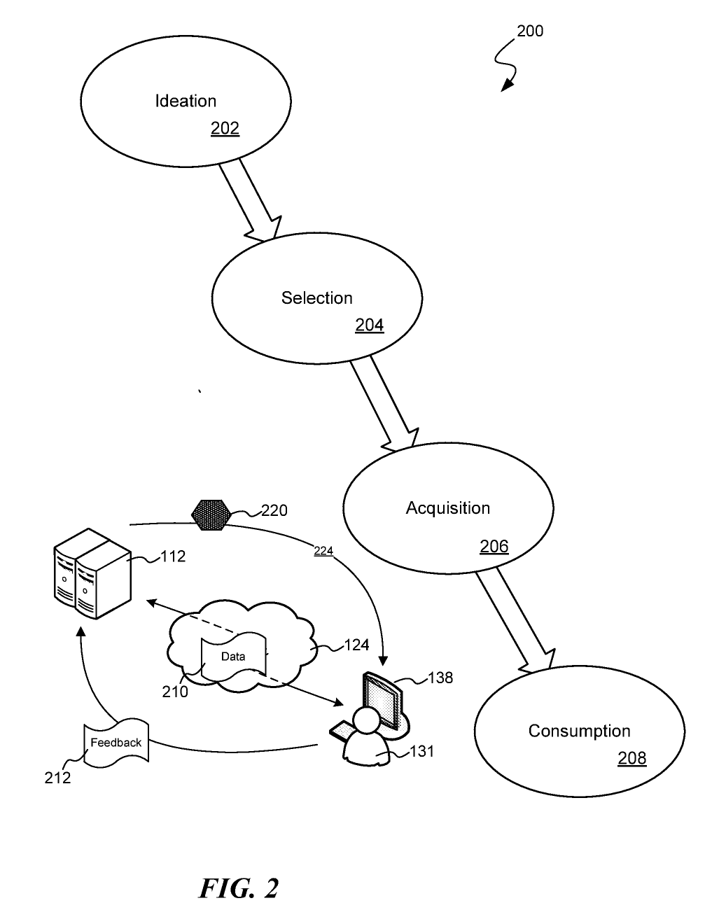

In regard to the interaction between the computer-executable tool and the foodstuff data aggregator 112, FIG. 2 is a pictorial diagram illustrating a high level process flow 200 with regard to capturing foodstuff data usage at a consumer household. As previously mentioned, foodstuff data 210 is provided to the foodstuff data aggregator 112 by various sources including, but not limited to, foodstuff vendors and user/consumers, through a wide area network 124. This foodstuff data is gathered and aggregated by foodstuff data aggregator 112. As previously indicated, foodstuff data aggregator 112 acts as the collector, aggregator, and interface between user/consumer 131 and foodstuff vendors 114-118 (shown in FIG. 1A). In addition to aggregating foodstuff usage data 210, the foodstuff data aggregator 112 may also receive user feedback data (regarding meals, recipes, products, user preferences, user restrictions, etc.) which is maintained by the foodstuff data aggregator for use in providing recommendations, identifying restrictions, updating loyalty programs, and the like.

Regarding the process of capturing foodstuff usage data 210 from various consumer households, as shown in FIG. 2 there are at least four general phases of the foodstuff data aggregator process, including: ideation 202, selection 204, acquisition 206, and consumption 208. Generally speaking, the ideation phase 202 corresponds to providing the user/consumer (by way of the computer-executable tool) with ideas and/or suggestions regarding what to prepare for one or more meals. The selection phase 204 corresponds to the user/consumer selecting from the various options that are presented in the ideation phase 202. The acquisition phase 206 corresponds to the acquisition of foodstuff (and other items) for the preparation of the selected meals. The consumption phase 208 corresponds to the preparation, usage and consumption of the selected meals or items. Other interactions outside of these phases also occur, such as providing feedback regarding menus and meals, updates regarding demographic data, offers and coupons directed to the consumers, and the like. As will be readily appreciated, in each phase of the process there is the potential for various foodstuff information to be received by and provided to the foodstuff data aggregator 112.

In addition to aggregating foodstuff data 210 from a plurality of consumers/households, the foodstuff data aggregator 112 further performs analysis of the aggregated data. Through this analysis, the foodstuff data aggregator 112 is able to identify key indicators regarding foodstuff purchase and/or usage, user or consumer decisions, limitations and preferences, correlations between foodstuff items and between foodstuff items and dates, functions, seasons, holidays, brand loyalties and brand loyalty relationships, and the like. According to aspects of the disclosed subject matter, as part of the analysis, the foodstuff data aggregator 112 will cause the foodstuff data to be aggregated, cleaned (i.e., data unrelated to foodstuff data usage and corresponding items are removed from the aggregated data), non-biased (i.e., restrict data participation groups from exceeding representative population sizes and/or demographic compositions), normalized (according to volume/amount, servings per person, etc.), and the key indicators from the aggregated data and analyzed are identified.

While not shown in FIGS. 1A-2, in addition to obtaining foodstuff usage data from users/consumers and/or households, the foodstuff data aggregator 112 may also receive foodstuff usage data from purchase agents that purchase foodstuff and foodstuff-related items on behalf of a consumer or a household. According to various embodiments, the purchase agents may report foodstuff usage data to the foodstuff data aggregator 112 according to arrangements between the purchase agents and the foodstuff data aggregator, on behalf of the consumer/household per arrangement between the purchase agents and the consumers/households, or by way of the computer-executable tool 220 in communicating with the purchase agents.

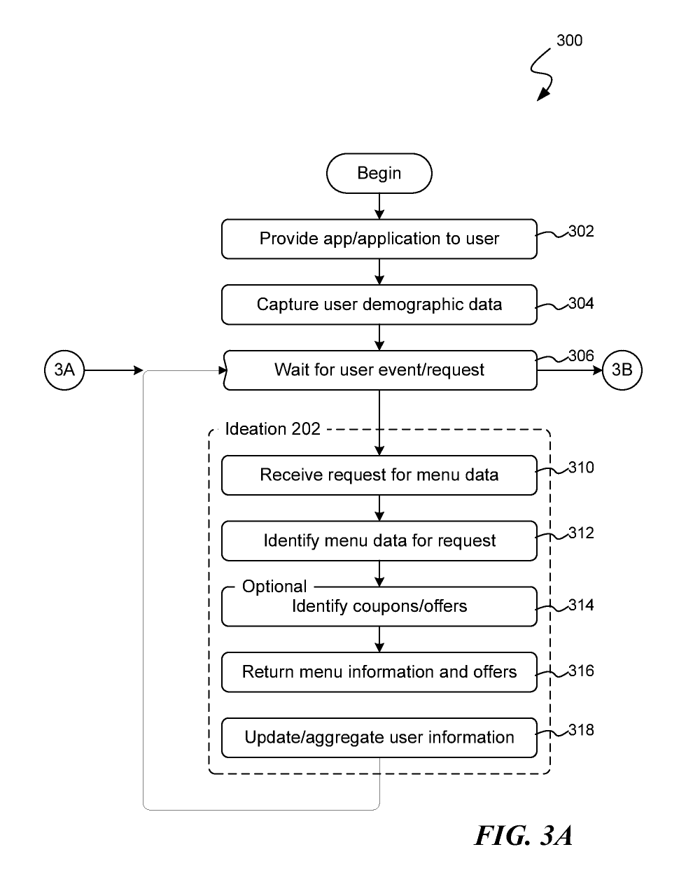

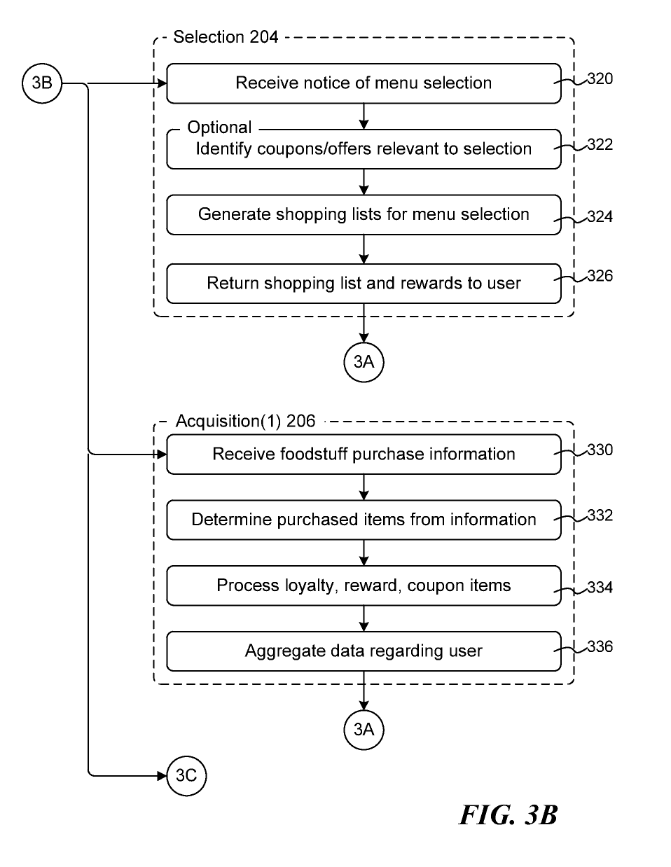

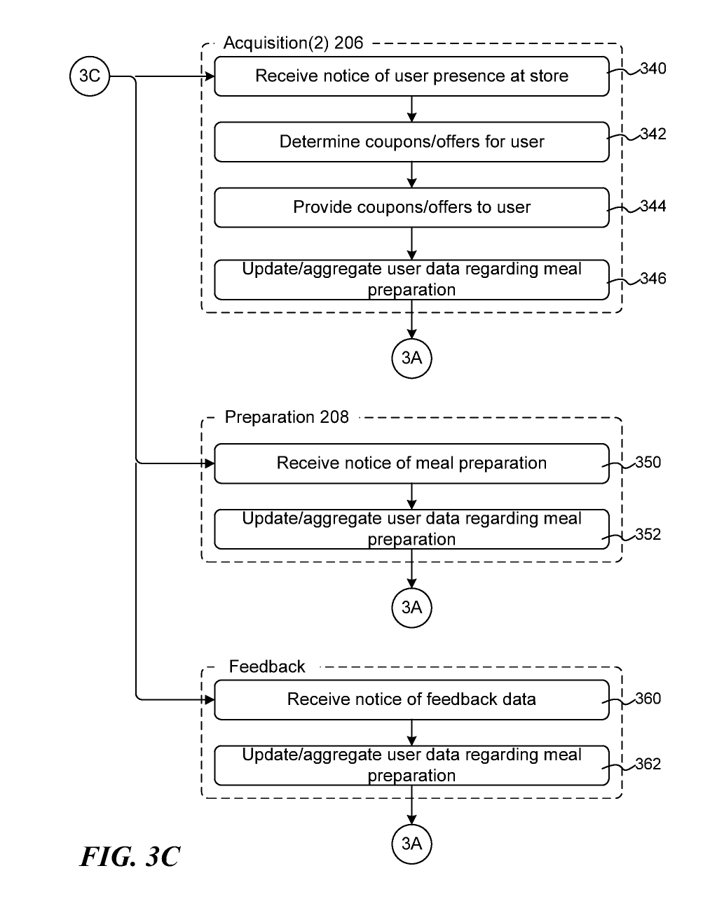

In order to more fully illustrate elements of each phase, reference is also made to FIGS. 3A-3C. FIGS. 3A-3C are flow diagrams illustrating exemplary routine 300 suitable for use by the data aggregator 112 to interface with the user/consumer 131 according to aspects of the disclosed subject matter. Thus, with reference to FIGS. 2 and 3A-3C, at block 302, the foodstuff data aggregator 112 provides the computer-executable tool 220, i.e., an app, web app and/or application, to the user/consumer 131, as indicated by arrow 224. As mentioned above, this tool/app is the means by which the foodstuff data aggregator 112 is able to send and receive foodstuff information, including consumers' foodstuff usage and/or consumption information, to and from a plurality of users, consumers and/or consumer households. At block 304 and as part of beginning use of the computer-executable tool 220, the tool captures and transmits to the foodstuff data aggregator 112 various user and/or consumer household demographic information, including, but not limited to: who the user is; age of the user; the number of people in the household; the geographic location of the household; various consumer and consumer household preferences such as favorite brands, types of foods, stores, etc.; and the like. Foodstuff usage data from that user/consumer/consumer household will be aggregated and associated with this demographic data. As will be appreciated, this user/consumer demographic data may then be used by the foodstuff data aggregator 112 in regard to queries from foodstuff vendors regarding foodstuff usage. Thereafter, at block 306, the data aggregator 112 waits for a user event/request, i.e., user interaction with the computer-executable tool 220.

Upon receipt of an idea information request from a user, the foodstuff data aggregator process enters the ideation phase 202. At block 310, the food data aggregator receives a request from the requesting user 131 for ideas and/or suggestions of what might be prepared, thus beginning the ideation phase 202. At block 312, the foodstuff data aggregator 112 identifies possible menu and/or meal options. According to aspects of the disclosed subject matter, the ideas and suggestions identified by the foodstuff data aggregator at block 312 may be based on criteria including, but not limited to, the requesting user or consumer household preferences (including preferences regarding the types of desired foods, the amount of preparation that may be involved, popular recipes, etc.), foodstuff items that may be on-hand and already available to the requesting user, requested cuisine, and the like. While not shown, in addition to providing information regarding ideas and suggestions, the foodstuff data aggregator 112 may also request and receive information from the user that identifies that foodstuff items are available to the user. Of course, the ideation phase 202 may be an iterative process and include learning capabilities based on user interaction during this phase.

In addition to providing suggestions and/or ideas for menu items, at block 314 the data aggregator 112 may, optionally, identify one or more coupons, reward information, and/or special offers from various foodstuff vendors. These offers (including the coupons, rewards, and other offers from foodstuff vendors) may be specifically targeted to the user according to the user's preferences, and/or may be directed to the user to complement the various menu items that are suggested. Of course, identifying the associated vendor coupons or special offers at the ideation phase 202 of the process and providing to the user/consumer 131 may aid the user in making a menu selection.

At block 316, the foodstuff data aggregator 112 returns the identified menu options and suggestions to the requesting user (along with any associated vendor rewards) for user selection. At block 318, the foodstuff data aggregator 112 aggregates and updates the user information in a user/consumer data store maintained by the foodstuff data aggregator. After the user/consumer data has been updated, the routine 300 returns again to block 306 to await notice of additional user events and/or requests from the foodstuff data aggregator 112. Of course, if the next request from the user is for additional menu items and/or suggestions, the routine 300 will return to block 310 and repeat the ideation phase 202 described above.

After completion of the ideation phase 202, the user will typically engage in the selection phase 204 (FIG. 3B). In this phase, the user 131 will typically select one or more menu items from the information obtained during one or more previous interactions in the ideation phase 202. Generally speaking, the selection process largely occurs on the user's computing device 138. However, as part of the user selecting one or more menus or dishes from the ideas and suggestions that were obtained during interaction in the ideation phase 202, selection of a menu (via the computer-executable tool 220 on the user computing device 138) will cause information to be uploaded to the foodstuff data aggregator 112. Thus, at block 320 (during the selection phase 204), the foodstuff data aggregator 112 receives notice of user 131 selection of one or more menu items for preparation. At block 322, various coupons, offers, and/or rewards that may be available from foodstuff vendors may optionally be identified in response relevant to the selections made by the user. At block 324, a shopping list is generated according to selected menu items. According to aspects of the disclosed subject matter, the shopping list is generated in consideration of foodstuff items that the foodstuff data aggregator 112 believes that the user has on-hand at the consumer household as maintained in the user/consumer data store. According to additional aspects of the disclosed subject matter, the shopping list identifies what is needed to complete the selected menus as well as what is needed to be purchased by the user (per the information maintained by the foodstuff data aggregator 112.) In this manner, if the foodstuff data aggregator 112 has incorrect information about what the user has available at the household, the user can identify what is needed to be purchased in order to have all foodstuff items needed to prepare the selected menu items, and thus continually improve the accuracy of household inventory. At block 326, the shopping list and the optional rewards (coupons, offers, reward notices, etc.) are returned to the user. Thereafter, the routine 300 returns to block 306 to await additional events and completing this user interaction in the selection phase 204.

As can be seen, by way of the computer-executable tool 220 users are encouraged to provide the foodstuff data aggregator 112 various items of foodstuff information. This foodstuff information provided to the foodstuff data aggregator 112 includes, by way of illustration and not limitation, purchases, consumption, shopping/store preferences, menu item preparation, and the like. As discussed above, the foodstuff data aggregator 112 receives (or acquires) user foodstuff information/data during the ideation phase 202 and the selection phase 204. In addition to these two phases, the foodstuff data aggregator 112 obtains user information through acquisition phase 206 and consumption phase 208, both of which are described below.

The acquisition phase 206 may be thought of as having two parts: the first (called “Acquisition 1” in routine 300 of FIG. 3B, is directed to processing a receipt of purchased foodstuff items. More particularly, after the user has purchased various foodstuff items, a copy of the receipt is uploaded to the foodstuff data aggregator 112, as indicated in block 330. The receipt (or some other form of purchased foodstuff information) may be provided by the user in various forms such as, by way of illustration and not limitation, taking a picture of the store receipt and uploading the picture to the foodstuff data aggregator 112, a user generated foodstuff list, capturing purchase information from one or more foodstuff stores, and the like. Once the purchased foodstuff information is received, at block 332 the data aggregator determines what foodstuff items were purchased. Depending on the type of purchased foodstuff information uploaded to the foodstuff data aggregator 112, a determination may be performed on the information to identify purchase information including, by way of illustration and not limitation, specific foodstuff items that were purchased (including brand/vendor information), quantities, purchase prices, data of purchase, location (store) of purchase, and the like. Advantageously, an image or picture of a receipt (or an electronic copy of the receipt) may be evaluated to extract information and data from the receipt, such as (by way of illustration and not limitation) product codes, store item numbers, item descriptions/names, quantities, brands, prices, and the like, any of which can be used to identify and/or correlate to specific brands, items, quantities and prices, which information may be provided to the foodstuff data aggregator 112. Of course, as will be readily appreciated by those skilled in the art, this foodstuff data aggregator process/routine 300 can be applied to any number of categories of non-foodstuff items, such as cleaning or personal hygiene items, cooking utensils, and the like, and not just limited to foodstuff or foodstuff-related items.

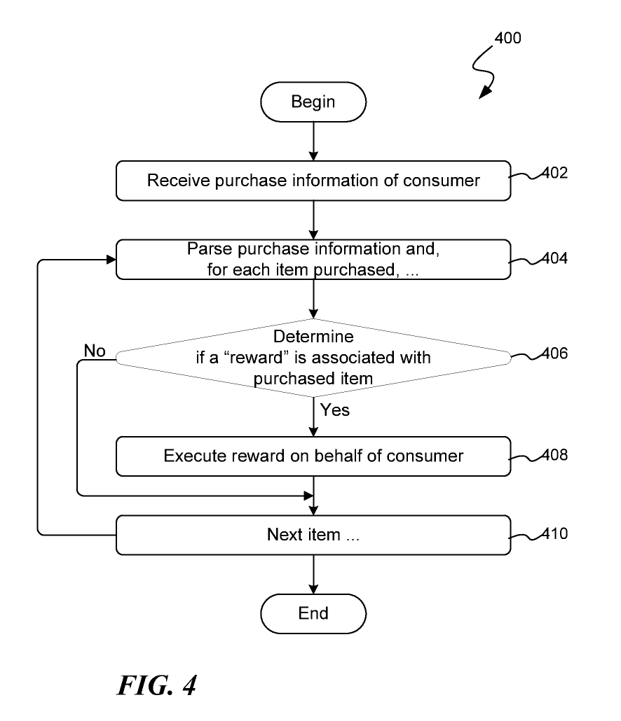

Returning to routine 300, after the specific items purchased are determined, at block 334 the routine 300 identifies and processes any applicable loyalty rewards, coupons, offers, and the like made or available to the user (directly or indirectly) and associated with the purchase of one or more foodstuff items. This may include, by way of illustration and not limitation, redeeming coupons on behalf of the user, updating loyalty reward programs, completing rebate information on behalf of the user, and the like. A more detailed description concerning management of the reward system for the user/consumer 131 is provided in the following description of FIG. 4. In addition to processing reward information, the foodstuff data from this user purchase/event is then aggregated and stored in association with the user's information in a data store maintained by the data aggregator 112, as indicated in block 336. Thereafter, the routine 300 returns to block 306 (via Circle 3A) and waits for additional/other user requests and/or events.

The second part of the acquisition phase 206, referred to as “Acquisition 2” in FIG. 3C, represents actions taken by the foodstuff data aggregators as a user is currently shopping in a particular store or an online store/e-commerce site. According to aspects of the disclosed subject matter, the computer-executable tool 220 includes geo-location tracking abilities and can determine when a user (inferred by the location of the user's mobile computing device) is at the location of a store. At block 340 the routine 300 receives notification of a user's presence in a grocery store (or some other store that may be of relevance to the foodstuff data aggregator 112). At block 342 a determination is made as to whether there are any applicable vendor offers or coupons that may be of use or interest to the user during the user's current store visit. This determination may be made by the foodstuff data aggregator 112 by using/comparing information from the various foodstuff vendors, a generated shopping list, current offers from the vendors, and the like. Once the applicable offers and/or coupons are identified, at block 344 they are provided to the user. Thereafter, at block 346, user-related data regarding store location, time, offers and coupons provided, and the like, is then updated and aggregated and stored. Thereafter, the routine 300 then returns to block 306 and waits for additional user requests and/or events.

With regard to the consumption phase 208, the computer-executable tool 220 may be configured to provide notice (block 350) to the foodstuff data aggregator 112 at the time that the user 131 uses elements of the tool for meal preparation. At block 352, foodstuff data aggregator 112 then updates/aggregates the user data (also referred to as the user's foodstuff usage data) regarding the user's meal preparation and stores the updated user data in the data store maintained by the foodstuff data aggregator. Regarding the user data, this data may include, by way of illustration and not limitation, food and/or dietary restrictions, number of people that may be eating, the number of people of the household, store preferences, menu preferences, available and types appliances, and the like. Thereafter, the routine 300 then returns to block 306 and waits for additional user requests and/or events.

As indicated above, in addition to the phases identified in FIG. 2, there are additional times that the foodstuff data aggregator 112 may further receive data relating to foodstuff usage and preparation. One such occasion is in regard to user feedback. As shown in FIG. 3C, at block 360 the routine 300 receives feedback data 212 from the user, regarding foodstuff related matters, such as (by way of illustration and not limitation) the need for portion size adjustment, menu preference suggestions, dates that foodstuff items/menus were prepared, the number of people to participate (eat) in the menu, whether or not the user liked the particular menu item and/or particular foodstuff items that were used to prepare the menu items, whether the preparation was too difficult, and the like. At block 362, this user feedback data 212 is aggregated and the user data (including personal information, foodstuff usage/consumption data, feedback data, and the like) corresponding to the user is updated and stored in the consumer data store maintained by the foodstuff data aggregator 112. The foodstuff data aggregator 112 routine 300 then returns to block 306 and waits for a user request or event.

Turning now to FIG. 4, FIG. 4 is a flow diagram illustrating an exemplary routine 400 suitable for use by the foodstuff data aggregator 112 to manage the reward system for the user/consumer 131. Routine 400 begins at block 402, when purchase information (regarding purchase of foodstuff items) is received from the user 131. Upon receipt of the user purchase information, at block 404, the purchase information is parsed to identify the specific items purchased and an iteration loop is begun to iterate through each of the purchased items. At decision block 406, a determination is made as to whether there is a reward associated with the currently iterated purchased item. This determination is made by the foodstuff data aggregator 112 in comparing the identified specific item to reward information the foodstuff data aggregator maintains from various foodstuff vendors. If a reward is determined to be associated with the specific item, at block 408, the foodstuff data aggregator 112 executes and/or carries out the actions necessary for the associated reward to be awarded to the user/consumer 131. At block 410, the routine 400 returns to block 404 to continue iterating through the purchased items. Of course, while not shown, in executing the various instructions to provide the associated reward to the consumer, the foodstuff data aggregator may also be capturing information regarding the consumer user's foodstuff purchases (as mentioned in regard to routine 300). Routine 400 repeats the process described in blocks 406-410 until all purchased items have been identified and all available rewards have been identified for each purchased item. When all available purchased items have been identified and all rewards have been identified for each purchased item and applicable rewards executed for each purchased item, as applicable, routine 400 terminates.

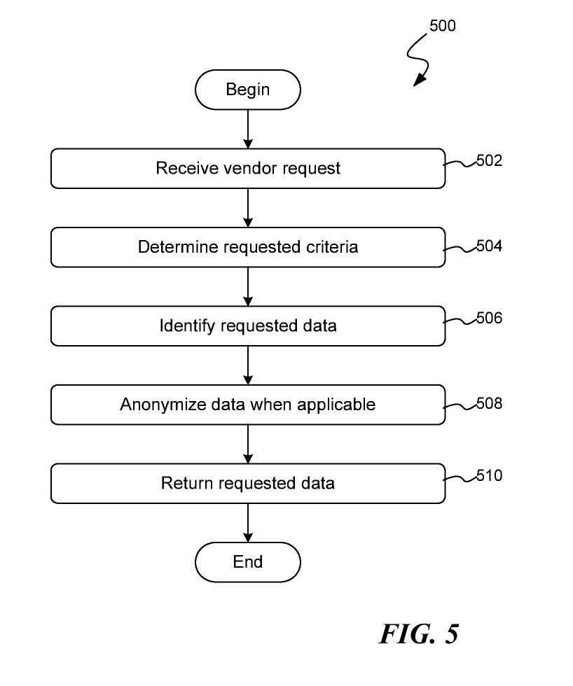

Turning now to FIG. 5, this figure is a flow diagram illustrating an exemplary routine 500 suitable for use by the foodstuff data aggregator 112 to interface with various foodstuff vendors. Beginning at block 502, the foodstuff data aggregator 112 receives a request from a vendor. At block 504, the foodstuff data aggregator 112 determines the nature and/or criteria of the vendor request. According to one embodiment, the request corresponds to an information request regarding foodstuff usage by one or more consumers/consumer households. The criteria identifies various limiting aspects, such as demographics, geographic locations, time periods, quantities, whether or not coupons or rewards were used, reward program members, and the like. Typically, though not exclusively, the criteria are chosen from a predetermined set of criteria, which criteria the foodstuff data aggregator 112 maintains and indexes the aggregated foodstuff and consumer usage information. Once the vendor request criteria are determined, at block 506, the foodstuff data aggregator 112 identifies the requested data from a consumer data store that it maintains to hold the user information as well as aggregated foodstuff data. When applicable, at block 508, the foodstuff data aggregator 112 may anonymize the requested data such that personal information and/or specific identifying information is not provided. This may occur when a user has requested that any personally identifying information, such as name, gender, age, address/location, and the like, not be shared with a vendor. Anonymization of personally identifying information is known in the art. After the requested data is anonymized (where applicable), at block 510 the data is then provided to the vendor at in response to the vendor request. Thereafter, routine 500 terminates.

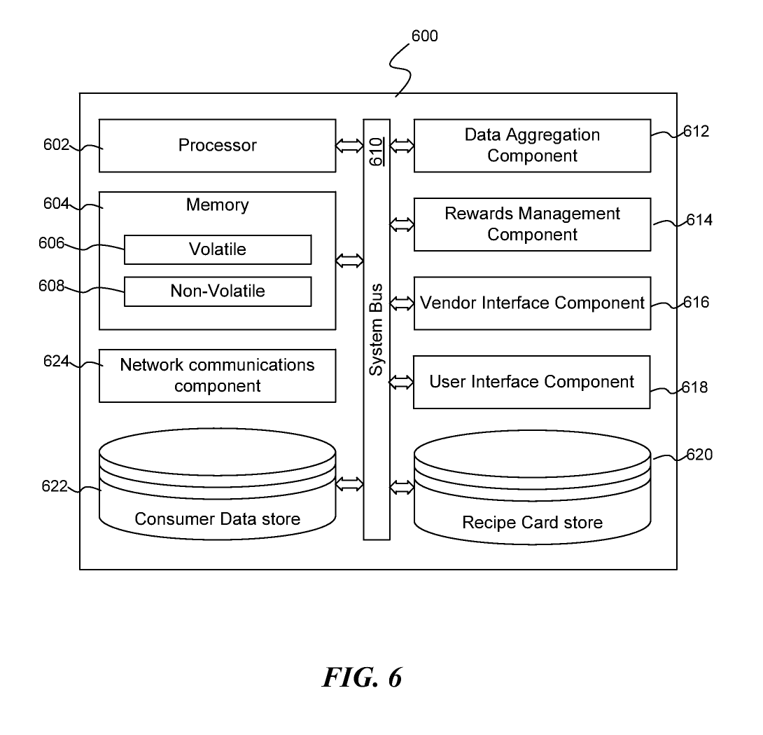

Regarding the routines described above (in FIGS. 3A-3C, 4 and 5), as well as other processes describe herein, while these routines/processes are expressed in regard to discrete steps, these steps should be viewed as being logical in nature and may or may not correspond to any actual and/or discrete steps of a particular implementation. Moreover, the order in which these steps are presented in the various routines and processes should not be construed as the only order in which the steps may be carried out. Further still, while these routines include various novel features of the disclosed subject matter, other steps (not listed) may also be carried out in the execution of the routines. Those skilled in the art will appreciate that logical steps of these routines may be combined together or be comprised of multiple steps. Steps of the above-described routines may be carried out in parallel or in series. Often, but not exclusively, the functionality of the various routines is embodied in software (e.g., applications, system services, libraries, and the like) that is executed on computing devices, such as the device described below in regard to FIGS. 6 and/or 7. In various embodiments, all or some of the various routines may also be embodied in hardware modules, including but not limited to system on chips, specially designed processors and or logic circuits, and the like on a computer system.

These routines/processes are typically implemented in executable code comprising routines, functions, looping structures, selectors such as if-then and if-then-else statements, assignments, arithmetic computations, and the like. They may be embodied in web apps, applications and/or apps, as well as system services. However, the exact implementation in executable and/or interpreted statements of each of the routines is based on various implementation configurations and decisions, including programming or encoding languages, compilers, target processors, operating environments, interpreter engines, and the link. Those skilled in the art will readily appreciate that the logical steps identified in these routines may be implemented in any number of ways and, thus, the logical descriptions set forth above are sufficiently enabling to achieve similar results.

While many novel aspects of the disclosed subject matter are expressed in routines embodied in applications (also referred to as computer programs), apps (small, generally single or narrow purposed, applications), web apps, and/or methods, these aspects may also be embodied as computer-executable instructions stored by computer-readable media, also referred to as computer-readable storage media. As those skilled in the art will recognize, computer-readable media can host computer-executable instructions for later retrieval and execution. When the computer-executable instructions that are stored on the computer-readable storage devices are executed, they carry out various steps, methods and/or functionality, including those steps, methods, and routines described above in regard to the various illustrated routines. Examples of computer-readable media include, but are not limited to: optical storage media such as Blu-ray discs, digital video discs (DVDs), compact discs (CDs), optical disc cartridges, and the like; magnetic storage media including hard disk drives, floppy disks, magnetic tape, and the like; memory storage devices such as random access memory (RAM), read-only memory (ROM), memory cards, thumb drives, and the like; cloud storage (i.e., an online storage service); and the like. For purposes of this disclosure, however, computer-readable media expressly excludes carrier waves and propagated signals.

Turning now to computer systems, FIG. 6 is a block diagram illustrating exemplary components of a computing system 600 suitable for implementing a foodstuff data aggregator 112 for aggregating foodstuff data from a plurality of users/consumers and/or consumer households, and further configured to interact with one or more foodstuff vendors as described above and according to the aspects of the disclosed subject matter. The computing system 600 includes a processor 602 (or processing unit) and a memory 604 interconnected by way of a system bus 610. As will be readily appreciated, the memory 604 typically (but not always) comprises both volatile memory 606 and non-volatile memory 608. Volatile memory 606 retains or stores information so long as the memory is supplied with power. In contrast, non-volatile memory 608 is capable of storing (or persisting) information even when a power supply is not available. Generally speaking, RAM and CPU cache memory are examples of volatile memory 606, whereas ROM, solid state devices, memory storage devices, and/or memory cards are examples of non-volatile memory 608.

The processor 602 executes instructions retrieved from the memory 604 in carrying out various functions, particularly in regard to aggregating foodstuff data from a plurality of consumer sources and in providing aggregated foodstuff data from a plurality of consumer sources to foodstuff vendors as described above. The processor 602 may be comprised of any of various commercially available processors such as single-processor, multi-processor, single-core units, and multi-core units. Moreover, those skilled in the art will appreciate that the novel aspects of the disclosed subject matter may be practiced with other computer system configurations, including but not limited to: personal digital assistants, wearable computing devices, smart phone devices, tablet computing devices, phablet computing devices, laptop computers, desktop computers, and the like.

The system bus 610 provides an interface for the various components of the computing system to inter-communicate. The system bus 610 can be of any of several types of bus structures that can interconnect the various components (including both internal and external components). The exemplary foodstuff data aggregator computing system 600 further includes a network communications component 624. The network communications component provides a communication interface to other components of the system by which the various components can communicate with other entities over a network, including users/consumers and/or consumer households, foodstuff vendors, and the like.

Also included in the foodstuff data aggregator computing system 600 is a data aggregation component 612. The data aggregation component 612 is configured to aggregate user foodstuff data from one or more users and/or consumer households. As described above, the data aggregation component 612 aggregates user foodstuff data for a plurality of users/consumers and/or consumer households regarding menu information, foodstuff purchase, demographic data and preferences, rewards and coupon items, user meal preparation, and the like. The aggregated data is stored in the consumer data store 622. Often, though not exclusively, the foodstuff usage data in the consumer data store is indexed according to a variety of keys such that a wide variety of requests from foodstuff vendors may be readily processed.

The foodstuff data aggregator computing system 600 also includes a rewards management component 614. As discussed above in regard to FIGS. 3A-3C, the rewards management component 614 is configured to maintain reward information regarding a plurality of users and/or consumer households, as well as reward information from a plurality of foodstuff vendors. Further, the rewards management component 614 is responsible for identifying when a reward is available to a user and configured to execute various actions in order to redeem one or more rewards for the plurality of users and/or consumer households.

The vendor interface component 616 provides the logical interface with one or more foodstuff vendors and/or related partners, such as foodstuff vendors 114-118, (typically by way of the network communications component 624). It is through the vendor interface component 616 component that the foodstuff vendors request foodstuff aggregation data from the foodstuff data aggregator 112. Similarly, the user interface component 618 provides the interface for the computer-executable tool 220 to obtain data from the foodstuff data aggregator 112 as well as provide foodstuff usage data to the foodstuff data aggregator 112. Additionally, through the vendor interface component 616 a related partner may offer suggestions to consumers/households, such as recommended wines, complementary dishes, take-out or in-home delivery options and the like.

Further still, the foodstuff data aggregator computing system 600 includes a recipe card store 620. The recipe card store includes the various menus, recipes and dishes (such as those found on recipe cards) that are presented to the user/consumer during the ideation phase 202. The various recipe cards stored in the recipe card store 620 may be directed to the preparation of an individual item and/or may be directed to the preparation of an entire meal.

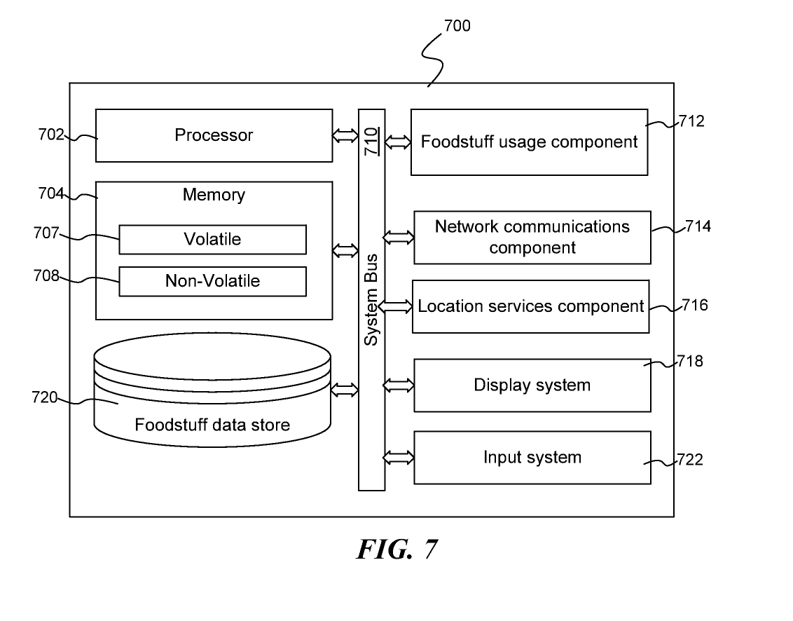

Turning to FIG. 7, FIG. 7 is a block diagram illustrating exemplary components of a user computing system 700 suitable for hosting a computer-executable tool for communicating with a foodstuff data aggregator 112, according to the aspects of the disclosed subject matter. The user computing system 700 includes a processor 702 (or processing unit) and a memory 704 interconnected by way of a system bus 710. As discussed above in regard to the computing system 600 of FIG. 6, the memory 704 of the user computing system 700 typically (but not always) comprises both volatile memory 706 and non-volatile memory 708. The processor 702 executes instructions retrieved from the memory 704 in carrying out various functions, particularly in regard to executing a computer-executable tool 220 that includes communicating foodstuff information with the foodstuff data aggregator 112. As above, the processor 702 may be comprised of any of various commercially available processors such as single-processor, multi-processor, single-core units, and multi-core units. Further still, the user computing system 700 includes a network communications component 714 by which the user computing system may communicate with other network entities over a network, including the foodstuff data aggregator 112.

The user computing system 700 also includes a foodstuff usage component 712 which, in various embodiments, corresponds to the computer-executable tool 220 described above. The foodstuff usage component 712 maintains user foodstuff data (including foodstuff items available for use, shopping lists, recipe cards, offers/rewards from vendors, and the like) in a foodstuff data store 720. Further, the user computing system 700 includes a location services component 716 that provides geographic location services to other components, including the foodstuff usage component 712. Also included in the user computing system 700 is a display system 718 by which the computing system presents information to a user, and an input system 722 by which the user interacts (provides input) to the user computing system 700.

Regarding the various components of the various computing systems 600 and 700, those skilled in the art will appreciate that many of these components may be implemented as executable software modules stored in the memory of the computing system, as hardware modules (including SoCs—system on a chip), or a combination of the two. Moreover, each of the various components may be implemented as an independent, cooperative process or device, operating in conjunction with or on one or more computer systems. It should be further appreciated; of course, that the various components described above in regard to the exemplary computing systems 600 and 700 should be viewed as logical components for carrying out the various described functions. As those skilled in the art will readily appreciate, logical components and/or subsystems may or may not correspond directly, in a one-to-one manner, to actual, discrete components. In an actual embodiment, the various components of each computer system may be combined together or broke up across multiple actual components and/or implemented as cooperative processes on a computer network.

As has been described above, by aggregating foodstuff usage data 210 from a plurality of households/users through the provision and use of a computer-executable tool 220, and making the aggregated foodstuff usage data available to foodstuff vendors and related partners, a business to individual (B2I) channel is established in regard to the foodstuff industry where such relationships/channel did not previously exist. Advantageously, foodstuff vendors and/or related partners are advantaged in that they can gain access to and insight from household foodstuff purchase and usage. Based on this information, foodstuff vendors are able to identify consumer households with foodstuff affinities, including type of foodstuff usage as well as brand affinities. This information may be used to reward customer loyalty, encourage additional use from consumers, and the like. On the household/consumer side, elements of the disclosed subject matter will provide greater efficiencies in considering what to cook, generating lists, assisting the preparation of meals and dishes, and the like. The household/consumer is advantaged by tracking and suggesting timely usage of perishable foodstuff items resulting in reduced foodstuff spoilage and loss.

While the above discussion is made largely in regard to users/consumers/households, and which may have an implication of a private person, the disclosed subject matter should not be construed as being limited to gathering information from private persons/households. Indeed, a user or consumer may be a chef for a household or for a commercial enterprise, a food preparation employee, a caterer (or member of a catering business), and the like.

While various novel aspects of the disclosed subject matter have been described, it should be appreciated that these aspects are exemplary and should not be construed as limiting. Variations and alterations to the various aspects may be made without departing from the scope of the disclosed subject matter.

What is claimed:

1. A computer-implemented method for gathering and providing user foodstuff data for foodstuff vendor requests, the method comprising:
providing a computer-executable tool to a plurality of users, wherein the computer-executable tool is configured to transmit foodstuff data to a foodstuff data aggregator regarding the plurality of users;
obtaining the foodstuff data from the plurality of users by way of the computer-executable tool (and extensions of the tool);
aggregating the obtained foodstuff data;
receiving a foodstuff data request from a foodstuff vendor, the foodstuff data request identifying request criteria;
identifying a set of results from the aggregated foodstuff data that satisfies the request criteria; and
providing at least some of the identified set of results to the foodstuff vendor in response to the foodstuff data request.

2. The computer-implemented method of claim 1, wherein the plurality of users are household consumers.

3. The computer-implemented method of claim 1, wherein the foodstuff data consists of foodstuff items already available to a corresponding user, and foodstuff purchase and consumption details that include any one or more of the following: purchase location, brand purchased, quantity purchased, how consumed, date consumed, and quantity prepared.

4. The computer-implemented method of claim 1, wherein each of the plurality of users are encouraged to provide user data and the foodstuff data with the provided tool by reward program offers.

5. The computer-implemented method of claim 4, wherein the reward program offers are determined for each user from user specific foodstuff data and include any one or more of the following: loyalty rewards, foodstuff coupons, meal planning recommendations, foodstuff recipes, and shopping lists.

6. The computer-implemented method of claim 1, wherein the foodstuff data is proactively tracked according to smart packaging on foodstuff items.

7. The computer-implemented method of claim 1, wherein the foodstuff data aggregator operates independently of the foodstuff vendor.

8. The computer-implemented method of claim 7, wherein the foodstuff data aggregator aggregates the foodstuff data by organizing the obtained foodstuff data according to any one or more of demographic data, purchase data and consumption data.

9. A computer-readable medium bearing computer-executable instructions which, when executed on a computing system comprising at least a processor retrieved from the medium, carry out a method for gathering and providing user foodstuff data for foodstuff vendor requests, the method comprising:
providing a computer-executable tool to a plurality of users, wherein the computer-executable tool is configured to transmit foodstuff data to a foodstuff data aggregator from the plurality of users;
obtaining the foodstuff data from the plurality of users;
aggregating the obtained foodstuff data;
receiving a foodstuff data request from a foodstuff vendor, the foodstuff data request identifying request criteria;
identifying a set of results from the aggregated foodstuff data that satisfy the request criteria; and
providing at least some of the identified set of results to the foodstuff vendor in response to the foodstuff data request.

10. The computer-readable medium of claim 9, wherein the plurality of users correspond to household consumers.

11. The computer-readable medium of claim 9, wherein the foodstuff data consists of foodstuff item availability, purchase and consumption details, including any one or more of the following: purchase location, brand purchased, quantity purchased, how consumed, date consumed, and quantity prepared.

12. The computer-readable medium of claim 9, wherein each of the plurality of users are encouraged to provide user data and the foodstuff data by way of the computer-executable tool by reward program offers.

13. The computer-readable medium of claim 12, wherein the reward program offers are determined for each user from user specific foodstuff data and include any one or more of the following: loyalty rewards, foodstuff coupons, meal planning recommendations, foodstuff recipes, and shopping lists.

14. The computer-readable medium of claim 9, wherein the foodstuff data aggregator operates independently of the foodstuff vendor.

15. The computer-readable medium of claim 14, wherein the foodstuff data aggregator aggregates the foodstuff data by aggregating the plurality of users obtained foodstuff data according to any one or more of demographic data, purchase data and consumption data.

16. The computer-readable medium of claim 9, wherein the foodstuff data is proactively tracked according to smart packaging on foodstuff items.

17. A computer system for gathering and providing user foodstuff data for foodstuff vendor requests, the system comprising a processor and a memory, wherein the processor executes instructions stored in the memory as part of or in conjunction with additional components to respond to the foodstuff vendor request, the additional components comprising:
a network communication component for communicating with one or more computing devices over a communication network;
a data aggregation component for aggregating foodstuff data from a plurality of users;
a user interface component configured to use a computer-executable tool for interfacing with the plurality of users, wherein the computer-executable tool is configured to transmit the foodstuff data to the data aggregation component;
a vendor interface component for interfacing with foodstuff vendors; and
a rewards management component for conducting rewards management of reward program offers for the plurality of users.

18. The computer system of claim 17, wherein the data aggregator component is configured to aggregate the obtained foodstuff data according any one or more of demographic data, purchase data, and consumption data.

19. The computer system of claim 18, wherein the data aggregator is further configured to assess the foodstuff vendor request and identify a set of results according to the foodstuff vendor request from the aggregated foodstuff data.
